(19) United States
(12) Patent Application Publication
(10) Pub. No.: US 2007/0006422 A1
(43) Pub. Date: Jan. 11, 2007

(54) Hinge with a torsion spring

(75) Inventors: Sheng-Nan Lu, Shulin City (TW); Te-Yang Liu, Shulin City (TW)

Correspondence Address: BIRCH STEWART KOLASCH & BIRCH, PO BOX 747, FALLS CHURCH, VA, 22040-0747, US

(73) Assignee: SHIN ZU SHING CO., LTD.

(21) Appl. No.: 11/402,807

(22) Filed: Apr. 13, 2006

(30) Foreign Application Priority Data
Jul. 7, 2005 (TW) 094211524

(51) Int. Cl. E05D 11/08

(52) U.S. Cl. 16/337

(57) ABSTRACT

A hinge with a torsion spring has a base, a pintle, at least one torsion spring, two joint members, and two washer assemblies. The base is attached to a support of an LCD display, and the pintle is mounted through the base. The torsion spring is mounted around the pintle, one end of the torsion spring is attached to the base, and the other end is attached to the joint member. When the angle of the display is adjusted, the joint members rotate relative to the pintle. With the torsion resilience provided by the torsion spring, the support will not be rotated with the joint members, so that the users can adjust the display angle with one hand.

### BACKGROUND OF THE INVENTION

1. Field of the Invention

The present invention relates to a hinge with a torsion spring, and particularly relates to a hinge that mounted between an LCD display and a support, to facilitate the angle adjustment of the display.

2. Description of the Related Art

The conventional LCD display is mounted on a support. A hinge is mounted between the support and the LCD display, whereby users can adjust the angle of the display. With reference to FIG. 6, a conventional hinge (80) has multiple elastic pieces (81). A pintle (82) is mounted through the elastic pieces (81), a joint member (91) of the display (90), and a joint member (93) of the support (92), and are fastened by fasteners (83). The display (90) can rotate relative to the support to change the angle and the friction between the elastic pieces (81) position the display (90).

However, the support (92) is much lighter than the display (90), when the angle of the display (90) is adjusted, the support (92) will be brought to rotate. Therefore, the user has to adjust the display (90) with one hand, and presses down the support (92) with the other hand to keep the support (92) stationary during the rotation of the display (90), and this is not convenient.

Therefore, the invention provides a hinge with a torsion spring to mitigate or obviate the aforementioned problems.

### SUMMARY OF THE INVENTION

The main objective of the present invention is to provide a hinge with torsion spring and comprising

a base having sleeves extending from two ends of the base, the sleeves each having an opening aligning with each other, two side faces of the base respectively having a lug;

a pintle mounted through the sleeves and having two non-circular shanks;

two joint members mounted at two ends of the pintle, and respectively having a slot to sliding holding one of the lugs of the base inside;

at least one torsion spring mounted on the pintle between the sleeves, each one of the at least one torsion spring having two ends attached respectively to the pintle and one of the joint members; and

two washer assemblies comprising multiple washers and elastic pieces mounted around the pintle, the washers and the elastic pieces all having non-circular through holes mounted securely on the shanks, two fasteners mounted securely on the two ends of the pintles.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of the hinge with a torsion spring in accordance with this invention;

FIG. 2 is an exploded perspective view of the hinge with a torsion spring in FIG. 1;

FIG. 3 is a side view of the hinge with a torsion spring in FIG. 1;

FIG. 4 is a side view of a second embodiment of the hinge in accordance with the present invention;

FIG. 5 is a perspective view of the hinge in FIG. 1 mounted on the display; and

FIG. 6 is a perspective view of a conventional hinge in accordance with the prior art mounted on the display.

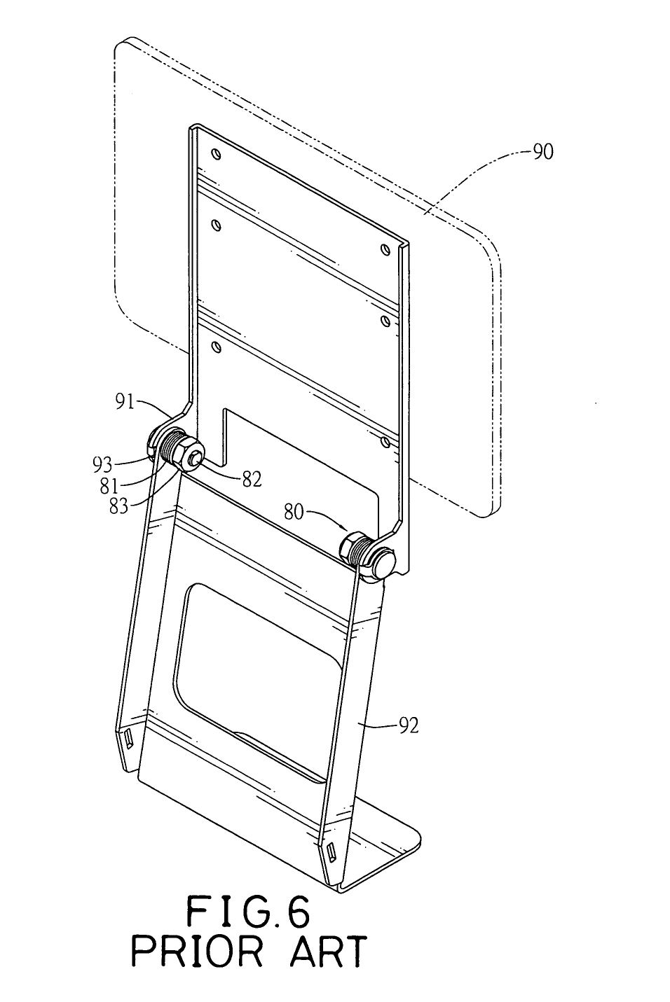

### DETAILED DESCRIPTION OF THE PREFERRED EMBODIMENT

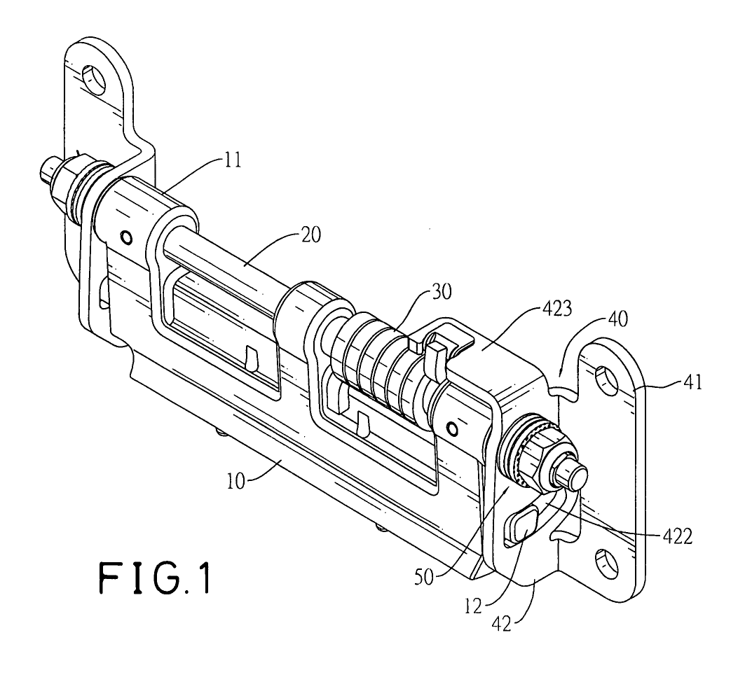

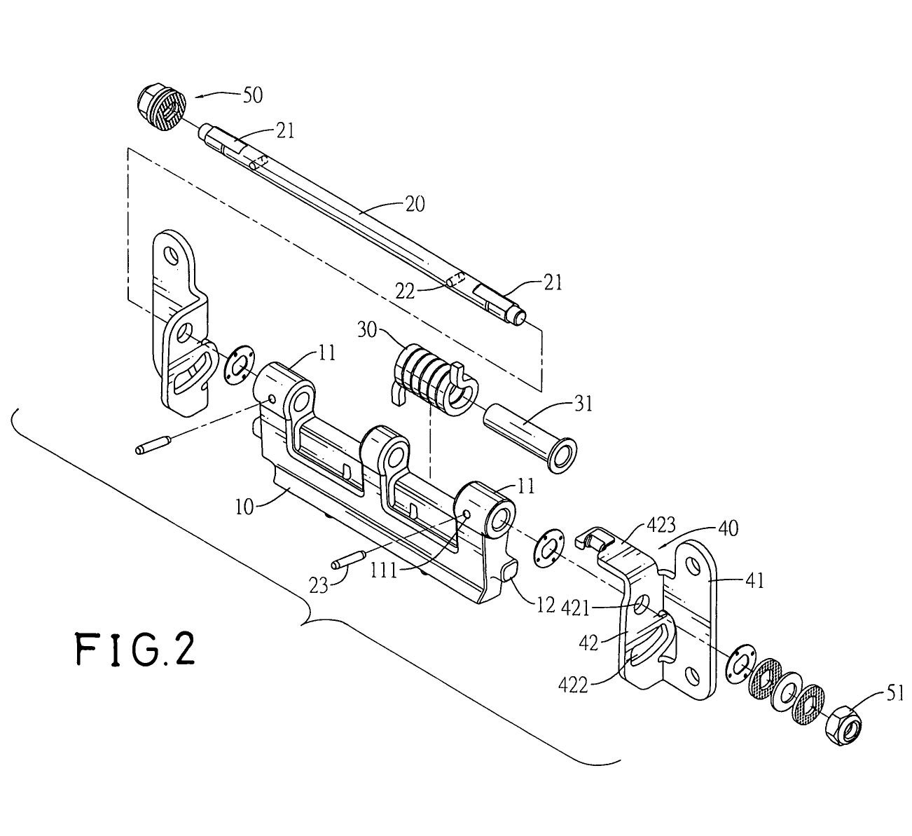

With reference to FIGS. 1-2, a hinge with a torsion spring in accordance with the present invention has a base (10), a pintle (20), at least one torsion spring (30), two joint members (40) and two washer assemblies (50). The base (10) has multiple sleeves (11) extending from two ends and a middle of the base (10). Openings of the sleeves (11) align to each other. The sleeves (11) at the two ends respectively have two first orifices (111) defined in the sleeves (11). Two side faces of the base (10) respectively have a lug (12) formed on the side face of the base (10).

The pintle (20) is mounted through the sleeves (11) and has two shanks (21) being non-circular and extending from two ends of the pintle (20). The pintle (20) has two second orifices (22) corresponding to the first orifices (111). Multiple bolts (23) are mounted respectively through the first orifices (111) and the second orifices (22), whereby the pintle (20) is fastened in the base (10).

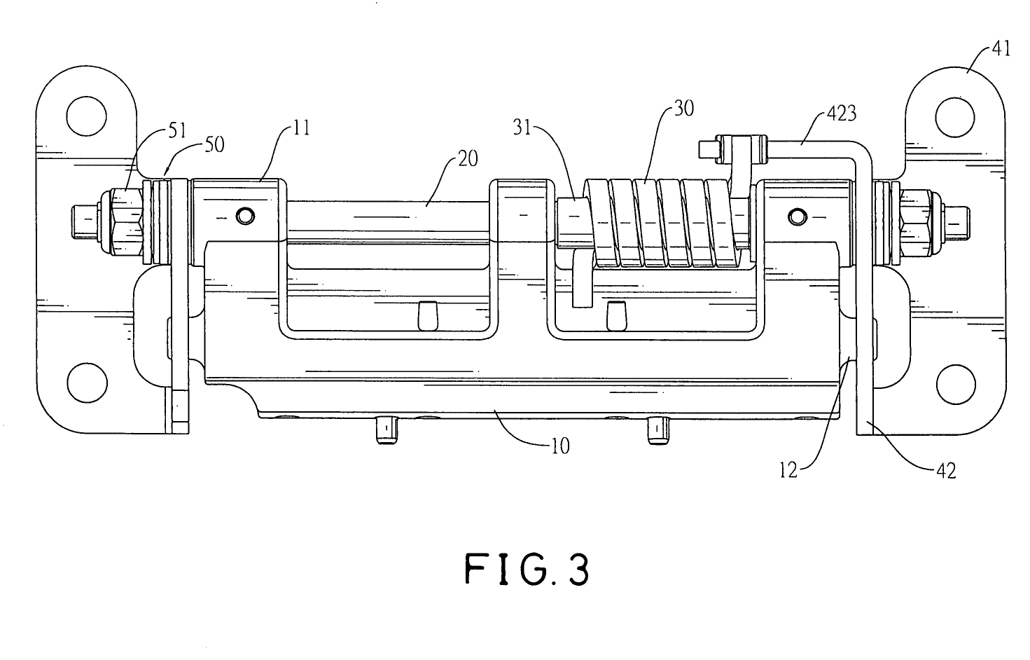

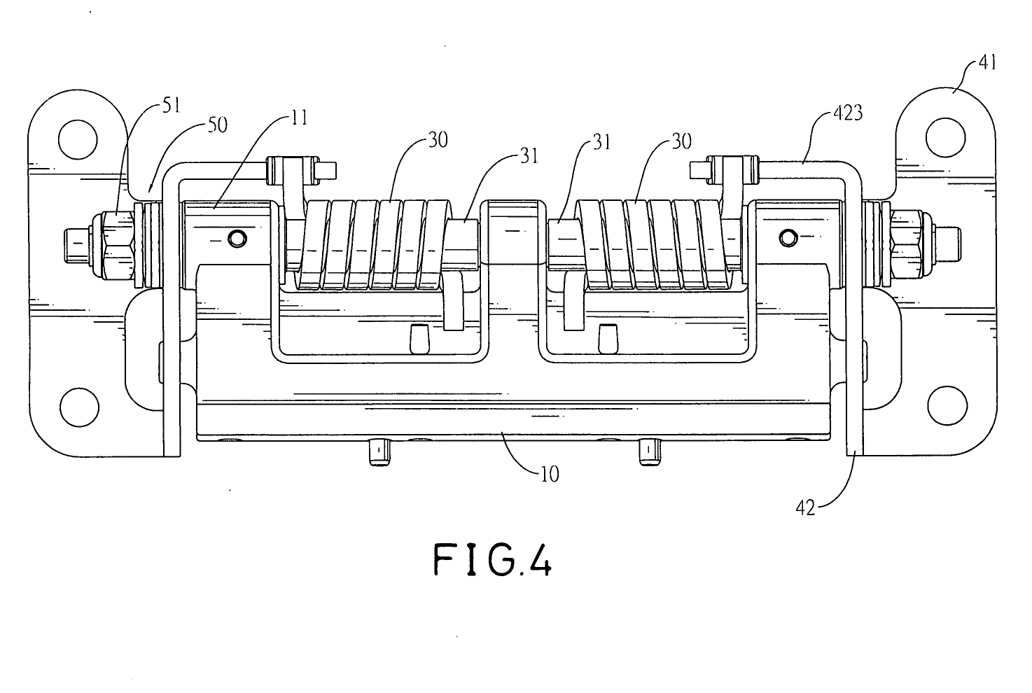

With reference to FIGS. 2-4, at least one torsion spring (30) is mounted around the pintle (20), and each torsion spring (30) is mounted between adjacent sleeves (11). The amount of the torsion spring (30) depends on the size of the LCD display. To keep the friction exerting directly between the torsion spring (30) and the pintle (20), the torsion spring (30) is mounted around a bush (31), and the bush (31) is mounted around the pintle (20).

The joint member (40) is mounted at two ends of the pintle (20), and has a fix wing (41) and a coupling wing (42) The fix wing (41) and the coupling wing (42) are perpendicular to each other so the joint member (40) is “L” shaped in cross section. The coupling wing (42) has a hole (421) defined in the coupling wing (42) and is mounted around the pintle (20), and a curved slot (422) is defined around the hole (421) and corresponds to the lug (12). The lug (12) is mounted slidably in the curved slot (422). In addition, the coupling wing (42) has an extended portion (423) formed toward the base (10). One end of the torsion spring (30) is attached to the base (10), and the other end of the torsion spring (30) is attached to the extended portion (423).

Each washer assembly (50) comprises multiple washers and elastic pieces mounted around the pintle (20). The washers and the elastic pieces all have non-circular through holes mounted on the shanks (21). Because the shanks (21) and the through holes of the washers and the elastic pieces are non-circular, the washer assembly (50) will not rotate relative to the pintle (20). Two fasteners (51) are mounted securely on the two ends of the pintles (20) to hold the washer assembly (50) and the joint members (40).

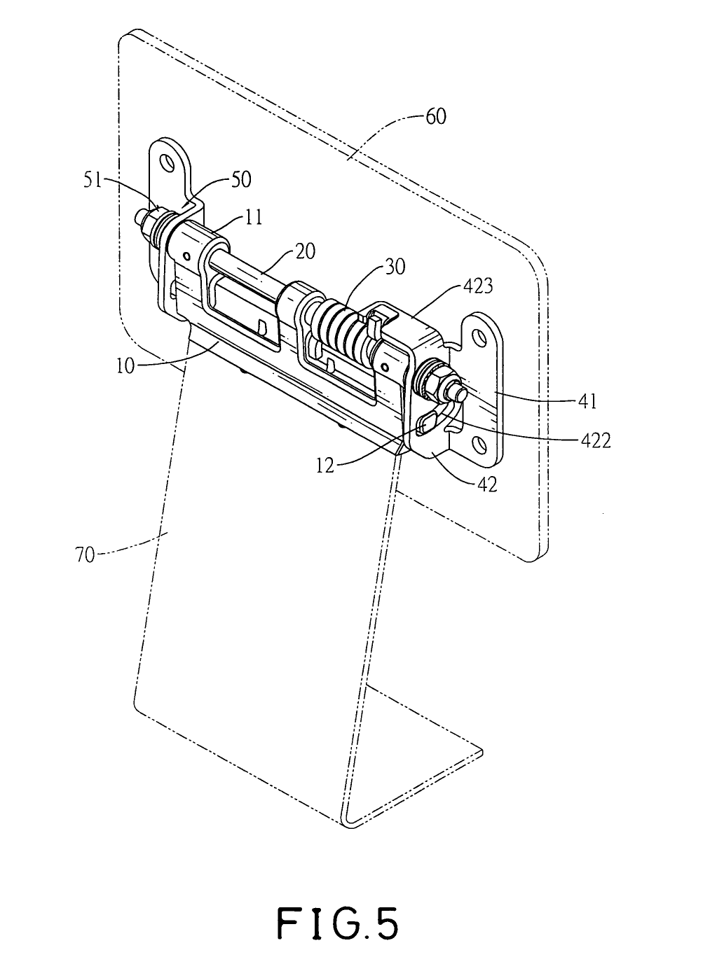

With reference to FIGS. 2 and 5, the fix wing (41) is attached to an LCD display (60), and the base (10) is attached to a support (70). When the angle of the display (60) is adjusted, the joint member (40) rotates around the pintle (20). The lug (12) is mounted in the slot (422), and when the lug (12) abuts one end of the slot (422), the display (60) can no longer rotates in this direction, whereby the rotation angle of the display (60) is limited. With the arrangement of the torsion springs (30) mounted between the base (10) and the extended portions (423) on the joint members (40), the base (10) will not be rotated with the joint member (40) with the torsion resilience provided by the torsion spring (40) that dismisses the rotation transmission from the joint members (40) to the base (10). Thus, the user can adjust the angle of the LCD display (60) with one hand.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a base having sleeves extending from two ends of the base, the sleeves each having an opening aligning with each other, two side faces of the base respectively having a lug;
a pintle mounted through the sleeves and having two non-circular shanks;
two joint members mounted at two ends of the pintle, and respectively having a slot to sliding holding one of the lugs of the base inside;
at least one torsion spring mounted on the pintle between the sleeves, each one of the at least one torsion spring having two ends attached respectively to the pintle and one of the joint members; and
two washer assemblies comprising multiple washers and elastic pieces mounted around the pintle, the washers and the elastic pieces all having non-circular through holes mounted securely on the shanks, two fasteners mounted securely on the two ends of the pintles.

2. The hinge with torsion spring as claimed in claim 1, wherein each joint member has a fix wing and a coupling wing, the fix wing and the coupling wing are perpendicular to each other, the coupling wing has a hole defined in the coupling wing and is mounted around the pintle, and a curved slot is defined around the hole of the coupling wing, and the coupling wing has an extended portion formed toward the base and connected to one end of a corresponding torsion spring.

3. The hinge with torsion spring as claimed in claim 1, wherein the base has a sleeve extending from a middle of the base and having an opening aligning with the openings in the sleeves on the ends of the base, and two torsion springs are mounted respectively between adjacent sleeves.

4. The hinge with torsion spring as claimed in claim 3, wherein the sleeves at the two ends of the base respectively have two first orifices defined in the sleeves, the pintle has two second orifices corresponding to the first orifices, and multiple bolts are mounted respectively through the first orifices and the second orifices.

5. The hinge with torsion spring as claimed in claim 4 further comprising two bush mounted around the pintle, wherein the torsion springs are mounted respectively around the bushes.
